(19) United States
(12) Patent Application Publication
(10) Pub. No.: US 2003/0004823 A1
(43) Pub. Date: Jan. 2, 2003

(54) Integrated procurement system facilitating the sharing of research and purchasing across multiple buying organizations

(75) Inventor: Giora Sagy, Belvedere, CA (US)

Correspondence Address: McCutchen, Doyle, Brown & Enersen, LLP, 18th Floor, Three Embarcadero, San Francisco, CA, 94111-4067, US

(73) Assignee: Epylon Corporation, San Francisco, CA

(21) Appl. No.: 09/896,934

(22) Filed: Jun. 28, 2001

(51) Int. Cl. G06F 17/60

(52) U.S. Cl. 705/26

(57) ABSTRACT

A purchasing system facilitates the use of sharing purchase vehicles across multiple buyers. In a database, purchase vehicles are stored, including the sharing purchase vehicles. The database also includes matching rule information associated with the sharing purchase vehicles. In addition, the database includes audit trail information corresponding to the sharing purchase vehicle information. A subset of the stored purchase vehicles is determined based at least in part on the stored matching rule information. The buyer selects a particular sharing purchase vehicle from the determined subset of the stored purchase vehicles, and the buyer transacts a purchase in accordance with the sharing purchase vehicle selected by the buyer. Audit trail information corresponding to the buyer-selected sharing purchase vehicle is associated with the purchase.

### TECHNICAL FIELD

The present invention relates to procurement systems and methods and, in particular, to a procurement system and method that facilitates the use of sharing purchase vehicles (such as “piggyback” contracts in California, or such as Joint Powers agreements and Coop Agreements in terminology of various states outside of California) across multiple buying organizations.

### BACKGROUND

Electronic procurement can be logically divided into three processes:

Procurement Research: Buyer identifies the product items which are most suitable for the specific purchase. Buyer identifies the product items, the supplier who will provide the product items and the price of the products.

Approval: Process to authorize the purchasing of goods within the buyer's organization in order to prevent abuses from within the organization.

Purchase: Process of ordering goods, order tracking and order fulfillment.

Conventionally, the source of product items is limited. Specifically, most conventional electronic procurement systems are limited to purchasing items listed in a “central” aggregated catalog (see, e.g., U.S. Pat. No. 5,319,542 to King et al.). Other conventional systems allow purchasing not only from a central aggregated catalog, but also supplement the central catalog with remote access to supplier catalogs.

The procurement process is complicated for some buying organizations by laws and regulations that require particular procedures be followed. For example, many educational buying organizations (e.g., school districts) are required to makes requests for proposals (RFP's) and requests for quotes (RFQ's) and also keep an audit trail to prove its due diligence. This is known generically as “proof of best selection of product”. Some organizations under the “proof of best selection of product” requirements have been able to take advantage of “sharable” contracts—“piggybackable” or “aggregated” contracts—where one purchaser enters into a contract, and the contract is available to be shared by other purchasers. Typical buying organizations that share contracts are school districts, state agencies, county agencies and federal government agencies. The widespread use of such “sharable” contracts has the potential to add much efficiency to the procurement process, while still retaining most if not all of the protections provided by “proof of best selection of product” requirements.

Unfortunately, currently, the amount of time and work required for a buying organization to manually seek out and track such sharable contracts is significant Of course, this also unnecessarily increases the amount of time and work required on the vendor side, to respond to inquiries from multiple buying organizations. Notably, typical electronic procurement systems do not facilitate the use of such “sharing” contracts.

Therefore, what is desired is a procurement system that facilitates the use of sharing contracts and other sharing purchase vehicles (such as shared bids and quotes).

### SUMMARY

In accordance with the invention, a purchasing system facilitates the use of sharing purchase vehicles across multiple buyers. In a database, purchase vehicles are stored, including the sharing purchase vehicles. The database also includes matching rule information associated with the sharing purchase vehicles. In addition, the database includes audit trail information corresponding to the sharing purchase vehicle information.

A subset of the stored purchase vehicles is determined based at least in part on the stored matching rule information. The buyer selects a particular sharing purchase vehicle from the determined subset of the stored purchase vehicles, and the buyer transacts a purchase in accordance with the sharing purchase vehicle selected by the buyer. Audit trail information corresponding to the buyer-selected sharing purchase vehicle is associated with the purchase.

### BRIEF DESCRIPTION OF FIGURES

FIG. 1 is a diagram of data and process flow that results from using an integrated repository of catalogs and sharing purchase vehicles.

FIG. 2 illustrates a functional flow of events corresponding to the buyer and supplier as each event relates to the integrated repository.

FIG. 3 illustrates in some detail the architecture of the integrated repository and its interfaces to user and supplier entities.

### DETAILED DESCRIPTION

In accordance with one aspect of the invention, an integrated procurement system is provided. This embodiment is first described broadly, and is then described more particularly with reference to the figures. Focusing first on the procurement research phase, in accordance with this aspect, an integrated repository includes sources for identifying product items:

supplier catalogs;

sharable contracts, entered into between buying organizations and suppliers to provide goods for a pre-specified price. These contracts are loaded into the system independently or are generated by the system from winning bids of specific suppliers.

sharable quotes provided by suppliers to buyers (typically, buyers other than the researching buyer) as a result of a quote requests. (These quotes are generated by suppliers as a result of request for quotes by the procurement system or are loaded/ generated from other procurement systems); and

sharable bids provided by suppliers to buyers as a result of bid requests. (These bids are generated by suppliers as a result of bidding requests by the procurement system or are loaded/ generated from other procurement systems)

Which sharable contracts and quotes (and other “shared” buying vehicles) are offered to a particular buying organization depends on “matching rules” provided in the integrated repository.

Furthermore, by using the integrated repository, a buying organization is provided an audit trail that proves the organization has indeed done the research (e.g., RFP's and RFQ's). Applicable regulations and laws many times require an audit trail. The audit trails include not only the research done by the particular buying organization, but also provide access to audit trails of research done by other buying organizations. By providing access to the audit trails of other organizations, the buying organization can “reuse” the research—providing significant time and labor savings yet still complying with the applicable regulations and laws. That is, a buying organization in a community can find product items that are part of a bid or quote provided to another buying organization and rely on the audit trail associated with that bid or quote.

Furthermore, when the buying organization puts a purchase out for bid or quote, the embodiment can automatically generate a contract from the bid responses. That is, when a supplier responds to a bid request, the embodiment automatically implements standard applicable procedures based on a database of business rules to select the winning response and to automatically generate a contract between the buying organization and the winning supplier organization.

Some embodiments of the invention support a regional/national Integrated Repository for research by buying organizations. This Repository allows organizations, which are part of a Community to reuse the Procurement Research that has been done by other community members. One example of a community is all the state, county and government institutions. These institutions typically require extensive research for most purchases. Using the integrated repository these institutions, can thus minimize their research activities (such as quotes and bids), instead relying on research, that has been done by other institutions. It should be noted, though, that the invention in its broadest aspects is not intended to be limited to a particular type of buying organization.

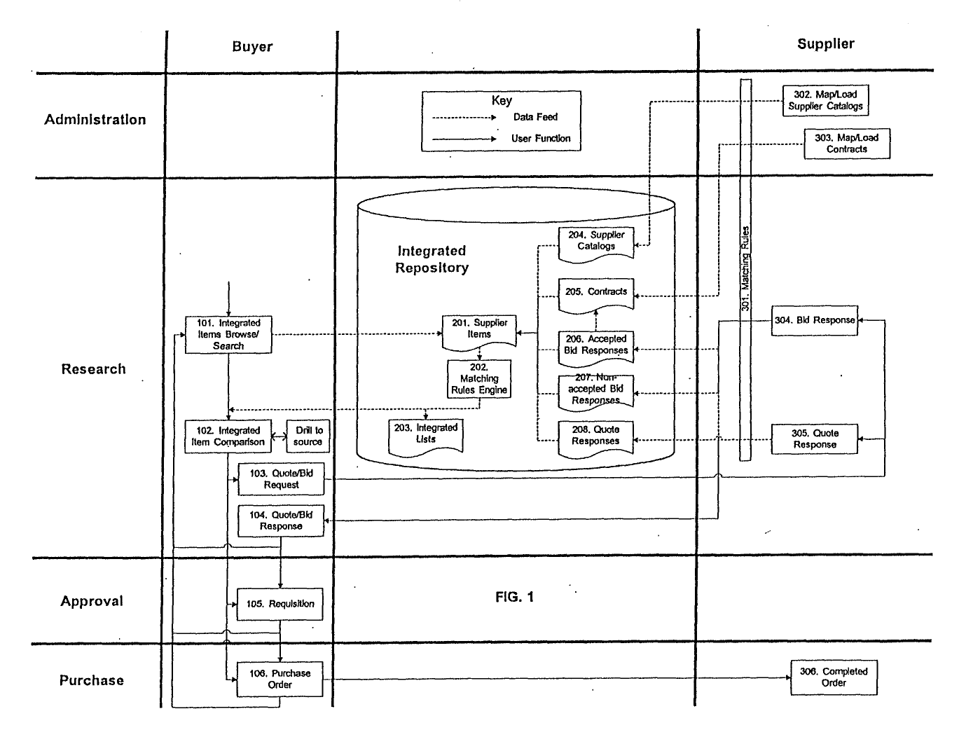

Reference is now made to FIG. 1 for a specific description of an embodiment. FIG. 1 is a diagram of data and process flow that results from using the integrated repository. The process and data points correspond to the buyer, supplier and the integrated repository areas. Each area is divided into the following tasks:

Administration—Administrative functions used to perform work within the integrated repository.

Research—Process and data points used to support a buyer's research of items they wish to purchase.

Approval—Functional area used to support the buyer's purchasing approval process.

Purchase—Functional area used to support the actual purchasing of items.

Now, the process and data points are described for each of buyer, supplier and integrated repository.

### Buyer

Basically, the buyer interface is a front end to a single searchable database that provides all the key information about each item in a convenient, single page format and sorts the products into common classifications such that similar products appear together. Each of the pricing records displayed is clickable to find more product information (possibly from a separate product database) or supplier information and the audit trail of that item. In the case of a contract it will provide the relevant contract information and a further path to the contract itself; in the case of a quote, it will provide the source of the quote, the original quote request, and the responses (including losing responses); in the case of a supplier's catalog it will provide the basis for the pricing (educational discount, retail price, etc.).

101. The buyer is provided search or browse functionality research items from the integrated repository. Searchable/browseable data comes from any of the following: supplier catalogs, contracts, bid responses and quote responses. The buyer may search or browse the integrated repository either by specifying the source or performing a generic search/browse across all sources.

102. Based on the results of the search/browse process, the buyer may compare items originating from all available sources. For each item, the buyer may drill down to review the source of the item. For a contract item, the buyer can review the contract from which the item originated, the terms and conditions of the contract and the institution, which contracted with the supplier. For quote/bid response items, the buyer can review the quote/bid request and the responses of the different suppliers.

103. The buyer is provided the ability to submit a quote or bid to the supplier(s).

104. Based on the quote or bid the buyer submits, the buyer receives responses from the supplier(s).

105. Upon aggregation of all appropriate items, the buyer may create a requisition. During this stage, the requisition is passed through an approval process. This process is a rules-based approval process for which each buying organization may set the workflow rules.

106. Upon completion of the approval process, the buyer may issue a purchase order to the supplier(s) from which their items correspond.

### Integrated Repository

201. Supplier items are sourced from any of the following: supplier catalogs, contracts, bid responses and quote responses.

202. The matching rules engine determines which items are to be returned to the buyer. Buyers may set the rules for which items they wish to view, or suppliers may set the rules for which items they wish the buyer to view. Rules are determined based on the following:

Buyer location—Buyers may be qualified for items based on their physical location.

Buyer enforced—Buyers may specify only those suppliers from which they would purchase.

Market segment—buyers qualify for items based on the segment of the market they belong to e.g. state, government or education sector

Cooperative—buyers qualify for items that are available to a cooperative they belong to

Contract rules—Specific contracts may apply only to certain buyers.

Supplier enforced—Suppliers may specify only those buyers to which they wish to sell.

Quote/bid rules—Quote and bid responses may be restricted to certain buyers.

203. Buyers may store selected items from the integrated repository into one or more list(s). Lists may be generic, shared within an organization or specific to a user. These lists are saved for processing at a later time.

204. Supplier catalogs are normalized and categorized into the integrated repository.

205. Contracts may be created in the integrated repository in one of at least two ways. The first way is by loading/mapping existing contracts into the integrated repository and assigning matching rules to those contracts. The second way occurs upon the conversion of an accepted bid into a contract.

206. After a buyer accepts a response to a bid, the response can be converted to a contract that may be used for future purchases by that buyer, or by several buying organizations (depending, for example, on the terms of the contract).

207. A supplier may specify that the response applies to buyers outside of the initiating buyer's organization. In other words, one buying organization may choose to leverage another buying organization's research by purchasing off of their bid response.

208. Terms of any request for quote response may be set by a supplier to allow other multiple buying organizations to purchase off of that quote response.

### Supplier

301. All data that is stored in the integrated repository is assigned matching rules to specify the target buying audience for the created item data. Suppliers are provided the ability to establish the matching rules in an attempt to ensure that the right buyers view their corresponding item information.

302. Tools are available to allow a large number of supplier catalogs to be created in the integrated repository. For example, a supplier may provide a supplier identified SKU, Description, Packaging, classification, and other product data relevant to listing in a catalog. Tools are provided to load, classify, and maintain the data and the applicability of the catalog to the buyers and buyer hierarchies based on any criteria available in the database. Items within these catalogs are normalized, mapped into the appropriate categories, and assigned matching rules.

303. Tools are available to allow an infinite number of supplier/buyer contracts to be created in the integrated repository. A tool is provided for creating and maintaining the applicability of any particular contract to any particular user both by the supplier and the buyer that initiated the contract. The rules for sharing the contract are varied and can include criteria such as location, business status, financial rating, and so on. Items within these contracts are normalized, mapped into the appropriate categories, and assigned matching rules.

304. Upon submitting a bid response to the buyer, a supplier may specify terms for the response to allow multiple buying organizations to leverage research already performed by a single buying organization.

305. Upon submitting a quote response to the buyer, a supplier may specify terms for the response to allow multiple buying organizations to leverage research already performed by a single buying organization.

306. Upon completion of the research and approval process of a particular buying organization, the supplier may receive and fulfill a submitted purchase order.

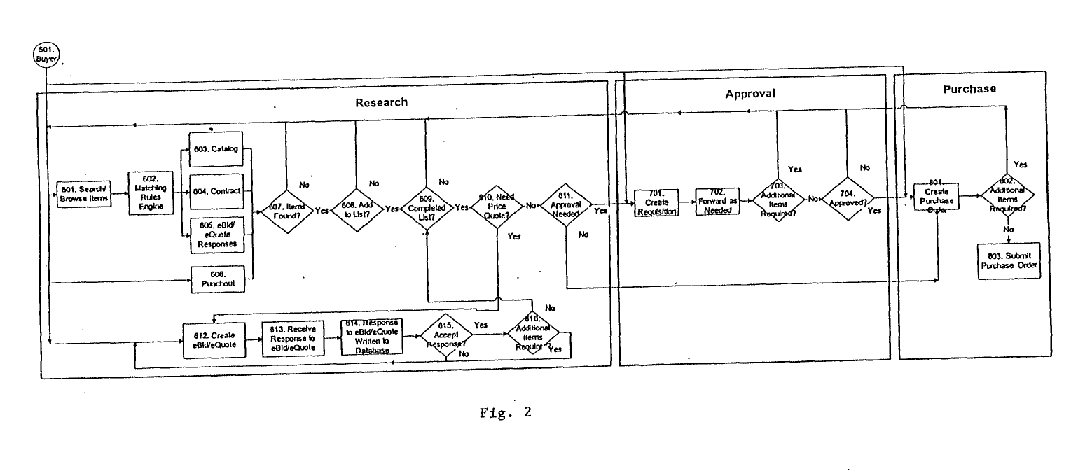

Now, a flowchart is provided in FIG. 2 that illustrates how the integrated repository is utilized. Specifically, FIG. 2 illustrates a functional flow of events corresponding to the buyer and supplier as each event relates to the integrated repository. The flow is categorized into the following areas:

Research—Flow of events to support a buyer's research of items for purchase.

Approval—Flow of events to support the buyer's purchasing approval process.

Purchase—Flow of events to support the actual purchasing of items.

### Buyer

501. A buyer may perform any of the functional duties (research, approval, and purchase) at any time, depending on existing processes. Buyers find the desired product items through a research process, which can be executed at different phases of the procurement process. The buyer may invoke the research process at the beginning of the procurement process or at any time through the approval or purchasing process. During the approval or purchasing process, the buyer might decide to buy another item (or group of items) and invoke the research process in the middle of the approval or purchase process.

### Research

601. The buyer is provided search or browse functionality to identify the items for purchase from the integrated repository. Searchable/browseable data comes from any of the following: supplier catalogs, contracts, request for bid responses and request for quote responses. During the research process, the buyer may either search/browse the entire integrated repository by specifying the desired source of the items or perform a generic search/browse across all sources.

602. Based on the buyer's profile, the matching rules engine determines the appropriate items from the integrated repository to present information to the buyer.

603. Items from supplier catalogs are available to the buyer and include information about the specified items the buyer chooses to research.

604. Items from contracts are available to the buyer and include contract information (items and contract descriptions) about the specified contracts the buyer chooses to research.

605. Responses to requests for bids and to requests for quote are available to the buyer and include detailed response information from the suppliers allowing the buyer to leverage research already performed on specific items.

606. Provided a supplier has a “punchout” solution available, the buyer may be directed to and choose to retrieve items directly from a supplier's internal web catalog solution This option is specifically useful if a supplier offers configurable items for sale on its website. This option allows the buyer to navigate to the supplier's web site, select the desired items and incorporate them in the buyer's list of items for purchase.

607. If the buyer is satisfied with the items retrieved from the integrated repository, the buyer may proceed to the next event. Otherwise, the buyer may choose to return to the beginning of the research process to perform additional searching or browsing of the integrated repository.

608. Once the buyer is satisfied with the item for which they are searching, the item may be added to a saved list from which they can either continue searching/browsing for additional items, or proceed to the next step. Buyers may choose to create multiple lists, some of which may be continuously reused to leverage past research.

609. After the buyer has completed their item list, they may proceed to the next event. If not, they may return to the beginning of the research process to continue searching or browsing.

610. Now that the buyer has a completed list, they determine if they have the appropriate pricing information to proceed to the next event. If the buyer must obtain additional pricing information, they may submit a request for bid or request for quote to one or many suppliers for some or all of the items on their list.

611. Once a buyer has completed all research for the items, they proceed to either the approval process or the purchasing process. If approval is required, they proceed to the approval process. Otherwise, they may be directed to the purchasing process.

612. A buyer may create either a request for bid or request for quote. The buyer may choose to issue their request for bid or request for quote to one or many suppliers.

613. Once a buyer has issued their request for bid or request for quote, including attributes such as when the response is needed by or specific terms and conditions, they receive responses from their selected suppliers. Another mechanism for generating pricing is an informal quote process. In this environment, a buyer communicates through the system with multiple suppliers to request quotes on one or many items. The supplier, in turn, communicates back through the system either typing information in free form, entering information in discrete fields similar to the fields mentioned above, or by attaching any number of electronic documents such as spreadsheets, word processing documents, web pages, or other formats. The suppliers also have the option of replying through phone or fax and the information is captured on the buyer's side.

614. The supplier's response to all requests for bids or requests for quote are written to the database to be researchable by other buying organizations. However, the supplier may specify matching rules to allow only targeted buying organizations to purchase from those responses.

615. From all responses the buyer receives, they may choose to accept or not accept. If they are not satisfied with any of the responses, they may either issue a new request for bid or request for quote, or return to the beginning of the research cycle. If they accept a response, they proceed to the next event.

616. If the buyer requires additional items, they may continue the research process. Otherwise, the items (with pricing information) from their request for bid or request for quote are added to their list.

### Approval

701. The buyer arrives at this step either by completing the research process, or by skipping the research process if they have the authority to create a requisition.

702. After creating a requisition, it is forwarded to the appropriate users (if necessary) within the buyer's organization according to their existing approval process.

During setup of the buyer's organization, the approval process rules are established and maintained within the buyer organization's profile.

703. During the approval process, if additional items are required, the buyer may go to the research process to locate the appropriate item information. Otherwise, the next event within the approval process is invoked.

704. If the requisition is denied by any of the buying organization users, they may return to the research process. If they approve of the requisition, they proceed to the purchasing process.

### Purchasing

801. The buyer arrives at this step either by completing the research and/or approval processes, or by skipping both processes altogether if they have the authority to create a purchase order.

802. During this process, if additional items are required, the buyer may go back to either the research or approval process. If not, they proceed to the next event.

803. Once the buyer is satisfied with all information on their purchase order, they may submit their information to the appropriate supplier(s).

The embodiment as described in FIGS. 1 and 2 may be applied in a similar fashion not only to purchasing through “Purchase Orders” but similarly to purchases with Procurement Cards, Credit Cards or other widely accepted payment methods.

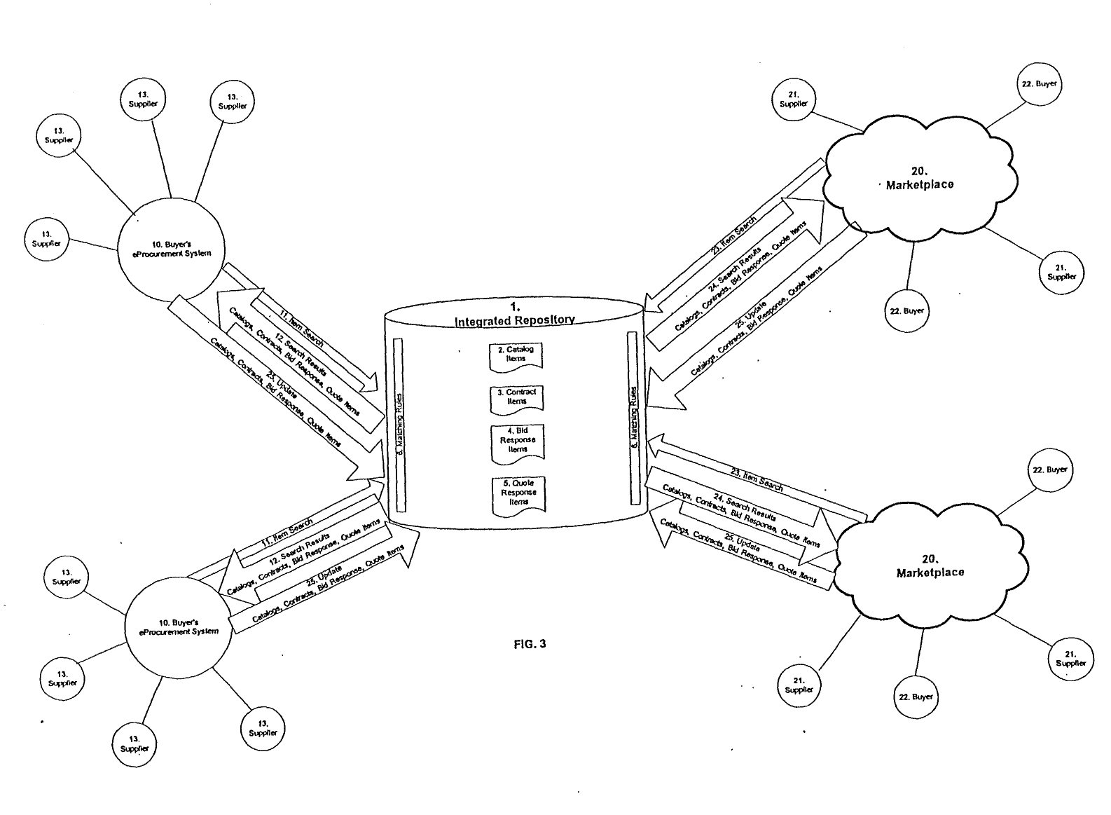

FIG. 3 illustrates in greater detail the architecture of the integrated repository and its interfaces to user and supplier entities. Such entities may exist, for example, in a marketplace (a community comprised of multiple buyers and suppliers) or as a buyer procurement portal (involving a relatively large buyer organization and multiple suppliers who are involved in commerce activities with the buyers).

### Integrated Repository

1. The integrated repository is a centralized database containing information that may be researched by any community. All communities may search, contribute or search and contribute to the integrated repository to create a constantly growing repository of searchable items.

2. Catalogs within the integrated repository are purchasable items (or services) from suppliers.

3. Contracts represent relationships between buyers and suppliers, and contain high-level contract information in addition to item information.

4. Responses to requests for bids are stored in the integrated repository and may be searched or created according to buyer/supplier specified matching rules. That is, the audit information is captured, formatted and loaded into a database for reference by the other potential users of the site. Typical fields found and captured are the sharing clause in the contract, contract validity dates, location of supplier, and so on. In some embodiments the data captured are all the winning bids and the losing bids together as well as a record of the request as it went out originally. The losing bids become a part of the audit trial (with time and date) and are stored and published according to similar mechanisms as described for contracts.

5. Responses to requests for quote are stored in the integrated repository and may be searched or created according to buyer/supplier specified matching rules.

6. Matching rules allow the appropriate presentation of the integrated repository to the appropriate buyers. Both buyers and suppliers may create rules to allow visibility to the content for which the buyers are qualified to view.

10. Buyer's procurement systems. 10. Buyers may have an existing procurement system that they use to perform research, approval and purchasing processes.

11. A buyer may perform research from the integrated repository.

12. Items are returned to the buyer based on matching rules in the integrated repository.

13. Suppliers are selling items to the buying organization utilizing buyer's procurement system

### Buyer 's Procurement Systems

20. An infinite number of marketplaces may interact with the integrated repository by searching or contributing.

21. Suppliers who interact with marketplaces may leverage the marketplace's interaction with the integrated repository by contributing catalog or contract information.

22. Buyers who interact with marketplaces may leverage the marketplace's interaction with the integrated repository by searching for items and updating the Repository with responses to a request for bid or request for quote.

23. Items are searched from the integrated repository.

24. Search results are returned to the marketplace according to the matching rules.

Return results may come from catalogs, contracts, responses to requests for bids, and/or responses to requests for quote.

25. Marketplaces may contribute to the integrated repository by sending catalogs, contracts, responses to requests for bids, and/or responses to requests for quote.

### Conclusion

An integrated procurement solution has been described that allows both buying and selling organizations to efficiently implement sharing contracts and other sharing purchase vehicles.

What is claimed is:

1. A purchasing system that facilitates the use of sharing purchase vehicles across multiple buyers, comprising:
(a) means for storing
(i) purchase vehicles including the sharing purchase vehicles,
(ii) matching rule information associated with the sharing purchase vehicles, and
(iii) audit trail information corresponding to the sharing purchase vehicles;
(b) means for determining a subset of the stored purchase vehicles based at least in part on the stored matching rule information;
(c) means for the buyer to select a particular sharing purchase vehicle from the determined subset of the stored purchase vehicles;
(d) means for the buyer to transact a purchase in accordance with the buyer-selected sharing purchase vehicle; and
(e) means for associating the audit trail information corresponding to the buyer-selected sharing purchase vehicle with the purchase.

2. The system of claim 1, wherein the storing means includes means for storing at least some of the sharing purchase vehicles and corresponding audit trail information in association with catalog listings for items to which the sharing purchase vehicles pertain.

3. The system of claim 1, wherein the means for storing sharing purchase vehicles includes means for storing sharing purchase vehicles that include at least one of contracts, quotes, bids, quote responses, and bid responses.

4. The system of claim 3, wherein:
(a) the purchase vehicle storing means is for storing purchase vehicles including catalogs.

5. The system of claim 1, and further comprising:
(a) means for creating purchase documentation based on the particular sharing purchase vehicle selected by the buyer,
(b) wherein the purchase documentation is used by the transacting means in completing the purchase.

6. The system of claim 1, wherein the subset selecting means includes means for processing the matching rules to select the subset of the stored sharing purchase vehicles that correspond to characteristics associated with a particular buyer.

7. The system of claim 6, wherein the matching rules processing means is further for matching characteristics of items, to which a sharing purchase vehicle pertains, to characteristics associated with a particular buyer.

8. The system of claim 1, wherein the matching rules include buyer-enforced rules, sharing purchase vehicle-enforced rules, supplier-enforced rules and quote/bid rules.

9. The system of claim 6, and further comprising:
(a) means for a particular buyer to cause matching rules to be stored by the matching rule storing means.

10. The system of claim 1, and further comprising:
(a) means for creating the sharing purchase vehicles.

11. The system of claim 10, wherein:
(a) the sharing purchase vehicles creating means is for creating the sharing purchase vehicles based on a request from a buyer that a sharing purchase vehicle be created.

12. The system of claim 11, wherein the buyer request is a request by the buyer to provide proposed terms for purchase of a particular item.

13. The system of claim 12, wherein the sharing purchase vehicle storing means automatically stores the sharing purchase vehicle upon creation by the sharing purchase vehicles creating means.

14. A purchasing system that facilitates the use of sharing purchase vehicles across multiple buyers, comprising:
(a) means for storing
(i) purchase vehicles including the sharing purchase vehicles;
(ii) matching rule information associated with the sharing purchase vehicles, and
(iii)audit trail information corresponding to the sharing purchase vehicles;
(b) means for determining a subset of the stored sharing purchase vehicles based at least in part on the stored matching rule information;
(c) means for providing to the particular buyer an indication of the selected subset of the stored sharing purchase vehicles;
(d) means for receiving an indication that the buyer has transacted a purchase in accordance with a particular one of the determined subset of the stored purchase vehicles; and
(e) means for associating the audit trail information corresponding to the particular purchase vehicle with the purchase.

15. The system of claim 14, wherein the storing means includes means for storing at least some of the sharing purchase vehicles and corresponding audit trail information in association with catalog listings for items to which the sharing purchase vehicles pertain.

16. The system of claim 14, and further comprising:
(a) means for receiving from the particular buyer an indication of a purchase of a particular one of the selected subset of the stored sharing purchase vehicles.
(b) means for associating the audit trail corresponding to the purchase vehicles with the purchase.

17. The system of claim 14, wherein the means for storing sharing purchase vehicles includes means for storing sharing purchase vehicles that include at least one of contracts, quotes, bids, quote responses, and bid responses.

18. The system of claim 14, and further comprising:
(a) means for receiving a selection of a particular sharing purchase vehicle from a buyer;
(b) means for creating purchase documentation based on the particular buyer-selected sharing purchase vehicle,
(c) wherein the purchase documentation is usable to complete a purchase of the item to which the buyer-selected sharing purchase vehicle pertains.

19. The system of claim 14, and further comprising:
(a) means for creating a sharing purchase vehicle and corresponding audit trail information based on interaction between buyers and sellers; and
(b) means for providing the created sharing purchase vehicle and corresponding audit trail to the sharing purchase vehicle storing means for storage thereby.

20. The system of claim 14, and further comprising:
(a) means for creating the sharing purchase vehicles.

21. The system of claim 20, wherein:
(a) the sharing purchase vehicles creating means is for creating the sharing purchase vehicles based on a buyer request that a sharing purchase vehicle be created.

22. The system of claim 21, wherein the buyer request is a request by the buyer to provide proposed terms for purchase of a particular item.

23. The system of claim 21, wherein the sharing purchase vehicle storing means automatically stores the sharing purchase vehicle upon creation by the sharing purchase vehicles creating means.

24. An electronic information retrieval system to facilitate use of sharing purchase vehicles, comprising:
(a) means for a buyer to search a database of item information to determine a particular subset of the items,, wherein the sharing purchase vehicles are associated with the items;
(b) means for accessing the sharing purchase vehicles for the items of the subset, and further for accessing audit trails corresponding to the accessed sharing purchase vehicles.

25. The system of claim 24, and further comprising:
(a) means creating purchase documentation for one of the items of the subset of items, based at least in part on the particular sharing purchase vehicle selected by the buyer,
(b) wherein the purchase documentation is usable to complete a purchase.

26. The system of claim 25, wherein:
(a) the sharing purchase vehicles have audit trail information associated therewith; and
(b) upon completion of the purchase, the audit trail information for which the purchase documentation is created is associated with the purchase.

27. An electronic information retrieval system to facilitate use of stored sharing purchase vehicles corresponding to items available for purchase, comprising:
(a) means for accessing the stored shared purchase vehicles;
(b) means for determining a subset of the stored sharing purchase vehicles based at least in part on matching rule information associated with the stored sharing purchase vehicles, wherein the subset determining means includes means for operating on the matching rule information to determine the subset of the stored sharing purchase vehicles; and
(c) means for setting the matching rules.

28. The system of claim 27, wherein:
(a) the matching rules setting means includes means for setting matching rules associated with a particular sharing purchase vehicle.

29. The system of claim 27, wherein:
(a) the matching rules setting means includes means for setting matching rules associated with the particular buyer.

30. A method of facilitating the use of sharing purchase vehicles across multiple buyers, comprising:
(a) storing
(i) purchase vehicles including the sharing purchase vehicles,
(ii) matching rule information associated with the sharing purchase vehicles, and
(iii)audit trail information corresponding to the sharing purchase vehicles;
(b) determining a subset of the stored purchase vehicles based at least in part on the stored matching rule information;
(c) selecting a particular sharing purchase vehicle from the determined subset of the stored purchase vehicles;
(d) transacting a purchase in accordance with the buyer-selected sharing purchase vehicle; and
(e) associating the audit trail information corresponding to the buyer-selected sharing purchase vehicle with the purchase.

31. The method of claim 30, wherein the storing step includes storing at least some of the sharing purchase vehicles and corresponding audit trail information in association with catalog listings for items to which the sharing purchase vehicles pertain.

32. The method of claim 30, wherein the step of storing sharing purchase vehicles includes storing sharing purchase vehicles that include at least one of contracts, quotes, bids, quote responses, and bid responses.

33. The method of claim 32, wherein:
(a) the purchase vehicle storing step includes storing catalogs.

34. The method of claim 30, and further comprising:
(a) creating purchase documentation based on the particular sharing purchase vehicle selected by the buyer,
(b) using the purchase documentation in the transacting step to complete the purchase.

35. The method of claim 30, wherein the subset selection step includes processing the matching rules to select the subset of the stored sharing purchase vehicles that correspond to characteristics associated with a particular buyer.

36. The method of claim 35, wherein the matching rules processing step includes matching characteristics of items, to which a sharing purchase vehicle pertains, to characteristics associated with a particular buyer.

37. The method of claim 30, wherein the matching rules include buyer-enforced rules, sharing purchase vehicle-enforced rules, supplier-enforced rules and quote/bid rules.

38. The method of claim 35, and further comprising:
(a) a particular buyer causing matching rules to be stored.

39. The method of claim 30, and further comprising:
(a) creating the sharing purchase vehicles.

40. The method of claim 39, wherein:
(a) in the sharing purchase vehicles creating step, the sharing purchase vehicles are created based on a request from a buyer.

41. The method of claim 40, wherein the buyer request is a request by the buyer to provide proposed terms for purchase of a particular item.

42. The method claim 41, wherein the sharing purchase vehicle storing is automatically stored upon creation.

43. A method of facilitating the use of sharing purchase vehicles across multiple buyers, comprising:
(a) storing
(i) purchase vehicles including the sharing purchase vehicles;
(ii) matching rule information associated with the sharing purchase vehicles, and
(iii)audit trail information corresponding to the sharing purchase vehicles;
(b) determining a subset of the stored sharing purchase vehicles based at least in part on the stored matching rule information;
(c) providing to the particular buyer an indication of the selected subset of the stored sharing purchase vehicles;
(d) receiving an indication that the buyer has transacted a purchase in accordance with a particular one of the determined subset of the stored purchase vehicles; and
(e) associating the audit trail information corresponding to the particular purchase vehicle with the purchase.

44. The method of claim 43, wherein the storing step includes storing at least some of the sharing purchase vehicles and corresponding audit trail information in association with catalog listings for items to which the sharing purchase vehicles pertain.

45. The method of claim 43, and further comprising:
(a) receiving from the particular buyer an indication of a purchase of a particular one of the selected subset of the stored sharing purchase vehicles.
(b) associating the audit trail corresponding to the purchase vehicles with the purchase.

46. The method of claim 43, wherein the step of storing sharing purchase vehicles includes storing sharing purchase vehicles that include at least one of contracts, quotes, bids, quote responses, and bid responses.

47. The method of claim 43, and further comprising:
(a) receiving a selection of a particular sharing purchase vehicle from a buyer;
(b) creating purchase documentation based on the particular buyer-selected sharing purchase vehicle,
(c) wherein the purchase documentation is usable to complete a purchase of the item to which the buyer-selected sharing purchase vehicle pertains.

48. The method of claim 43, and further comprising:
(a) creating a sharing purchase vehicle and corresponding audit trail information based on interaction between buyers and sellers; and
(b) storing the created sharing purchase vehicle and corresponding audit trail.

49. The method of claim 43, and further comprising:
(a) creating the sharing purchase vehicles.

50. The system of claim 49, wherein:
(a) the step of creating sharing purchase vehicles includes creating the sharing purchase vehicles based on a buyer request that a sharing purchase vehicle be created.

51. The system of claim 50, wherein the buyer request is a request by the buyer to provide proposed terms for purchase of a particular item.

52. The system of claim 50, wherein the sharing purchase vehicle is automatically stored upon creation.

53. An method of facilitating use of sharing purchase vehicles, comprising:
(a) searching a database of item information to determine a particular subset of the items, wherein the sharing purchase vehicles are associated with the items;
(b) accessing the sharing purchase vehicles for the items of the subset, and further accessing audit trails corresponding to the accessed sharing purchase vehicles.

54. The method of claim 53, and further comprising:
(a) creating purchase documentation for one of the items of the subset of items, based at least in part on the particular sharing purchase vehicle selected by the buyer,
(b) wherein the purchase documentation is usable to complete a purchase.

55. The method of claim 53, wherein:
(a) the sharing purchase vehicles have audit trail information associated therewith; and
(b) upon completion of the purchase, the audit trail information for which the purchase documentation is created is associated with the purchase.

56. A method of facilitating use of stored sharing purchase vehicles corresponding to items available for purchase, comprising:
(a) accessing the stored shared purchase vehicles;
(b) determining a subset of the stored sharing purchase vehicles based at least in part on matching rule information associated with the stored sharing purchase vehicles, including operating on the matching rule information to determine the subset of the stored sharing purchase vehicles; and
(c) setting the matching rules.

57. The method of claim 56, wherein:
(a) the matching rules setting step includes setting matching rules associated with a particular sharing purchase vehicle.

58. The method of claim 56, wherein:
(a) the matching rules setting step includes setting matching rules associated with the particular buyer.
